(19) United States
(12) Patent Application Publication
(10) Pub. No.: US 2017/0140672 A1
(43) Pub. Date: May 18, 2017

(54) RADIAL ARM MODEL WITH MESH

(71) Applicants: Mario Alves Simoes, Pinellas Park, FL (US); EJ Worley, Tampa, FL (US)

(72) Inventors: Mario Alves Simoes, Pinellas Park, FL (US); EJ Worley, Tampa, FL (US)

(73) Assignee: University of South Florida, Tampa, FL (US)

(21) Appl. No.: 15/350,741

(22) Filed: Nov. 14, 2016

Related U.S. Application Data
(60) Provisional application No. 62/254,459, filed on Nov. 12, 2015.

(51) Int. Cl. G09B 23/30; G09B 9/00

(52) U.S. Cl. CPC G09B 23/303; G09B 9/00

(57) ABSTRACT

A radial arm model in combination with a two-way mesh to permit puncturing, dissection/transection, and suturing of the underlying simulation vessels. The current invention also includes a method of training for such a procedure using said model, along with a method of fabricating or manufacturing such a model.

### CROSS-REFERENCE TO RELATED APPLICATIONS

This nonprovisional application is a continuation of and claims priority to U.S. Provisional Patent Application No. 62/254,459, entitled “Radial Arm Model with Mesh”, filed Nov. 12, 2015 by the same inventors, the entirety of which is incorporated herein by reference.

### BACKGROUND OF THE INVENTION

1. Field of the Invention

This invention relates, generally, to surgical models for training purposes. More specifically, it relates to radial arm models.

2. Brief Description of the Prior Art

Radial arm models for training purposes are known in the art. Examples include THE CHAMBERLAIN GROUP's Open Radial Artery Trainer, THE CHAMBERLAIN GROUP's Endo Radial Artery Trainer, CAROLINAS HEALTHCARE SYSTEM' s Arterial Puncture Trainer, LAERDAL's Arterial Arm Stick Kit, and KYOTO KAGAKU's Arterial Puncture Training Wrist. Each of these products, however, only allow for simulated transection/dissection of the vessel or puncture. None allow for suturing of the vessel, which is critical to effective training for real-life procedures, as these procedures do not terminate after just transection and dissection of the vessel.

Accordingly, what is needed is a radial arm model that permits puncture, dissection and suturing of the underlying model vessels. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need for an improved radial arm simulation model is now met by a new, useful, and nonobvious invention.

In an embodiment, the current invention is a radial arm simulation model resembling a human radial arm including a two-way mesh layer disposed around simulated blood vessels for suture simulation.

In another embodiment, the current invention is a radial arm simulation model. The simulation model includes a plurality of silicone layers representing skin, fat, and muscles in a human radial arm. The silicone layers are similar to the skin, fat, and muscles in structure and texture. The simulation model further includes a plurality of silicone tubings representing blood vessels in the human radial arm. The silicone tubings are similar to the blood vessels in structure and texture. Artificial blood is disposed in the silicone tubings, and a port is positioned within at least one of the silicone tubings in order to simulate pulsatile flow of the artificial blood through the tubing. A two-way mesh is disposed around each of the tubing and encloses each tubing. This mesh facilitates simulation of suturing of the blood vessels in the human radial arm.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawing, in which:

The FIGURE is a schematic of a radial arm showing relevant portions of the arm to be simulated by the model according to certain embodiments of the current invention.

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

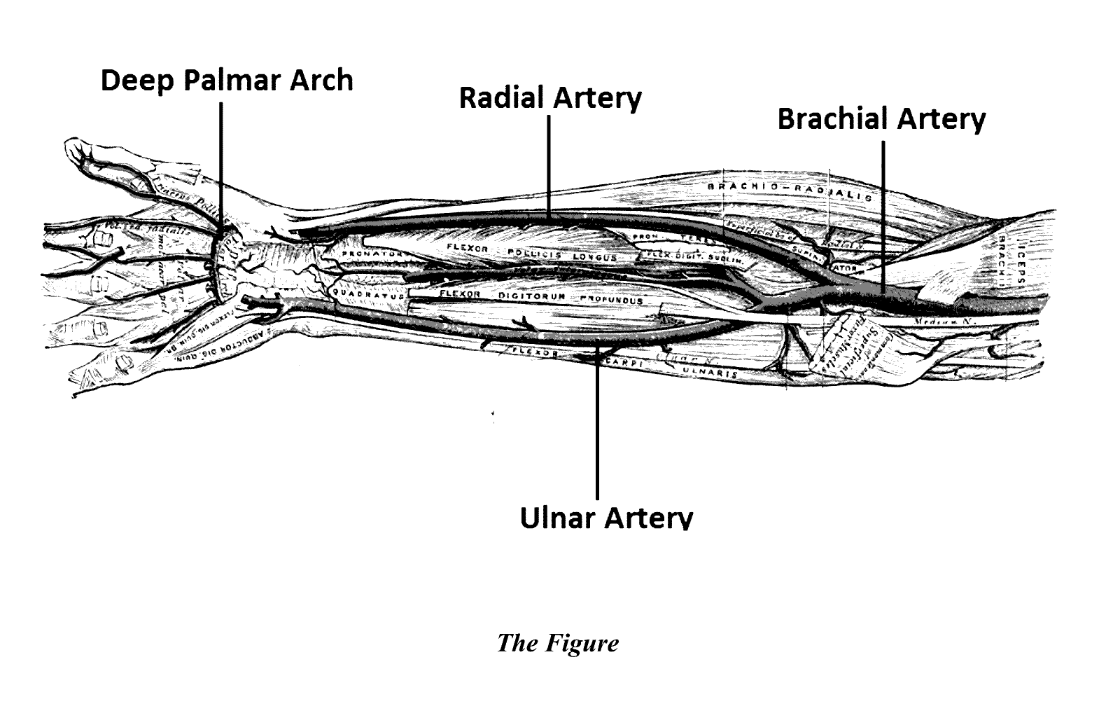

In an embodiment, the current invention is a radial arm model and method of use and manufacture thereof. The radial arm model includes the appropriate layers (e.g., skin, fat, muscles) and vessels to simulate an actual arm of a human being, substantially as shown in FIG. 1. Each vessel may be a silicone tubing with or without mesh disposed around the tubing. Ports are positioned at the vessels to allow for pulsatile flow of artificial blood through the vessels.

In certain embodiments, a two-way mesh technology is included in the model and encloses the vessels within the model. The combination of the mesh with the radial arm model allows for the suturing of the vessels within the model, whereas the prior art only allows for transection/dissection of the vessel or puncture. It is highly advantageous to have a surgical model that can be punctured, dissected and sutured, which is lacking in the prior art. The current invention solves this problem by including two-way mesh enclosing the vessels to be dissected and sutured.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A radial arm simulation model resembling a human radial arm including a two-way mesh layer disposed around simulated blood vessels for suture simulation.

2. A radial arm simulation model, comprising:
a plurality of silicone layers representing skin, fat, and muscles in a human radial arm, wherein said plurality of silicone layers are similar to said skin, fat, and muscles in structure and texture;
a plurality of silicone tubings representing blood vessels in said human radial arm, wherein said plurality of silicone tubings are similar to said blood vessels in structure and texture.
artificial blood disposed within said plurality of silicone tubings;
ports positioned within at least one of said plurality of silicone tubings in order to simulate pulsatile flow of said artificial blood; and
a two-way mesh disposed around and enclosing each of said plurality of silicone tubings in order to facilitate simulation of suturing of said blood vessels in said human radial arm.
